(19) United States
(12) Patent Application Publication
(10) Pub. No.: US 2009/0248477 A1
(43) Pub. Date: Oct. 1, 2009

(54) PRIMARY PRODUCTS PRODUCTION SYSTEM AND METHOD

(76) Inventor: Angela Bowles, Brighton (AU)

Correspondence Address: WINSTEAD PC, P.O. BOX 50784, DALLAS, TX, 75201, US

(21) Appl. No.: 12/272,067

(22) Filed: Nov. 17, 2008

Related U.S. Application Data
(63) Continuation of application No. 10/472,287, filed on Oct. 21, 2003, now abandoned.

(30) Foreign Application Priority Data
Feb. 26, 2001 (AU) PR 3358
Oct. 30, 2001 (AU) PR 8562

(51) Int. Cl. G06Q 10/00; G06F 17/00; G05D 1/00

(52) U.S. Cl. 705/8; 700/107; 700/103; 701/300; 705/28

(57) ABSTRACT

A primary product production system and a method of supplying raw material for the production. The raw material is provided in a manner, inter-alia, that is an improvement in the delivery and/or selection of supplied materials used. In a particular form, the product results from metal making and/or the coal industry. In a generic overall description, a customer specifies a processed product as set out in an order which typically includes quality and quantity of processed product such as pig iron or other product, and places it. Changes may also be made. This information is input to a database/computer which then determines from the order which sources of raw materials to the foundry or refinery to produce a primary product which fulfils customer orders and/or changes. The raw material(s) may be supplied from any asset.

### CROSS-REFERENCE TO RELATED APPLICATIONS

This patent application is a continuation of U.S. patent application Ser. No. 10/472,287. U.S. patent application Ser. No. 10/472,287 is a national-stage filing of PCT Patent Application No. PCT/AU2002/00195, filed Feb. 25, 2002. Both of the above-listed patent applications are incorporated by reference.

### BACKGROUND

1. Field of the Invention

The present invention relates to a primary product production system, and a method of supplying material for a primary product production system. More particularly, but not by way of limitation, the present invention is directed to the provision of raw materials in a manner that provides, inter-alia, an improvement in the delivery and/or selection of supplied materials used in primary product production systems and methods.

2. History of the Related Art

Systems and methods used for the supply of raw materials and the production of a primary product are generally based on a large scale. For example, in the production of Hot Metal, raw materials, such as iron ore and coal are sourced from separate mines, which are usually geographically remote from the foundry site where the Hot Metal is produced. These bulk raw materials are then usually transported great distances by road and/or rail and/or ship and a system of cranes and conveyors to the foundry. However, it is current practice also to stockpile the raw materials so that the supply of the raw materials into the foundry can be coordinated with foundry output and customer orders. In other words, raw materials are generally mined and transported to a stockpile near the foundry or a remote site until they are required by the foundry.

In business terms, a stockpile is considered to be an under-utilised asset. In effect, there are costs associated with the provision of a site to store the raw materials, lost opportunity cost in terms of cash flow, in that expenses have been incurred in the mining/supply of raw materials, including transport, but the materials have not yet been converted into a saleable commodity and customers have not yet purchased the commodity, meaning the foundry has not yet had the benefit of cash flow from commodity sales. There is a need to better utilise assets.

Where customers have specific needs, such as a need for the supply of Hot Metal having specific specifications and composition, the foundry usually supplies Hot Metal falling within a range of parameters as set out, usually, in a 12-month supply contract. The contract may provide a relative premium price for Hot Metal having a certain preferred composition, and also provide a relatively poor price for Hot Metal not having the preferred composition. It is known that the characteristics of raw materials vary for mine to mine, and even vary within each mine. Thus a stockpile of material from a mine or a number of mines will include possibly great variations in the raw material characteristics. When the stockpile is fed to the foundry, due to the variations in the composition of the raw materials supplied to the foundry, it is difficult to provide a relatively consistent grade of Hot Metal and thus, the foundry has difficulty in producing Hot metal of a quality within a customer's contract range and may, in fact, produce Hot Metal which falls outside the range acceptable to customers. This Hot Metal outside a customer's range is difficult, if at all possible, to sell, and thus represents another under-utilised asset of the business.

De-phosphorising plants have been utilised in the past to overcome the problem of the production of Hot Metal which is unacceptable to the foundry's customers. This involves further and/or additional processing of the Hot Metal. Not only does this involve the construction and operation of another plant, but the reprocessing involves moving the liquid Hot Metal to this intermediate plant, then bubbling an inert gas plus the de-phosphorising agent (e.g., calcium fluoride or barium fluoride) through the Hot Metal. This chemical action separates the phosphorous into a slag which is skimmed off prior to returning the Hot Metal to the processing chain, all of which incurs further expense in the supply of Hot Metal to customers. There is a need to enable the supply of Hot Metal which is more consistent in meeting specified parameters of customers.

Further improvements are also considered necessary in the manner in which materials are supplied to the foundry. Current practices of supply of material to a foundry, such as the supply chain, are primarily based on a linear programming technique. This is a supply chain of raw materials based largely on a lowest cost delivery basis. In this regard, FIG. 1 illustrates an example supply chain for the supply of the main raw materials for the production of Hot Metal. Mines 1, 2 and 3 indicate raw material sources. They may be iron ore, coal, and/or other materials. These are transported 7 to stockpiles 4, 5 or delivered to a port 8 for transport by a ship. At some point in time, the materials are delivered to the foundry either from the mine 1 directly, from stockpiles 4, 5 and/or the ship from port 8. The materials are provided to the foundry for the production of Hot Metal. As noted above, the present supply chain arrangements tend to result in the production of Hot Metal of varying quality or characteristics. There is therefore also considered to be a need to provide an alternative and/or improved supply chain.

### SUMMARY OF THE INVENTION

A system includes a network operable to provide information for production at a processing site of a primary product ordered by a customer and a computer interoperably coupled to the network. The computer is operable to receive an order includes a plurality of requirements for the primary product and a customer delivery date, determine a plurality of raw materials needed to produce the primary product in accordance with the plurality of requirements and the customer delivery date, the plurality of raw materials not being present at the processing site, and determine, via a network-accessible tag associated with each of a plurality of assets from which the plurality of raw materials may be obtained, information regarding the plurality of assets. The information includes raw-material transport times to the processing site and information regarding at least one of a physical property and a functional capability of each of the plurality of assets. The computer is also operable to coordinate, based on the information regarding the plurality of assets, sourcing of the plurality of raw materials from at least one of the plurality of assets so that the customer delivery date is met with minimal underutilization of the plurality of raw materials and repeat the coordination of sourcing responsive to changes in the information regarding the plurality of assets.

A method includes receiving, via a network, an order includes a plurality of requirements for a primary product and a customer delivery date, determining, by a computer interoperably coupled to the network, a plurality of raw materials needed to produce the primary product in accordance with the plurality of requirements and the customer delivery date, the plurality of raw materials not being present at the processing site, and determining, by the computer via a network-accessible tag associated with each of a plurality of assets from which the plurality of raw materials may be obtained, information regarding the plurality of assets. The information includes raw-material transport times to the processing site and information regarding at least one of a physical property and a functional capability of each of the plurality of assets. The method also includes coordinating, by the computer based on the information regarding the plurality of assets, sourcing of the plurality of raw materials from at least one of the plurality of assets so that the customer delivery date is met with minimal underutilization of the plurality of raw materials, and repeating by the computer of the coordinating step responsive to changes in the information regarding the plurality of assets.

A method includes creating, via a computer interoperably coupled to a network, a supply chain of a plurality of raw materials not present at a processing site, the supply chain applicable to a customer order for a primary product to be produced at the processing site. The supply chain includes a plurality of assets from which the plurality of raw materials are to be sourced. The method also includes tracking, by the computer via the network, each of the plurality of assets via a network-accessible tag associated with each of the plurality of assets. The tracking step includes the computer receiving information via the network from the network-accessible tag. The information includes raw-material transport times to the processing site and information regarding a physical property and a functional capability of each of the plurality of assets. The method also includes, responsive to the tracking step, modifying the supply chain via the computer and the network. The modifying step includes replacing at least one of the plurality of assets with a different asset of the plurality of assets.

The above summary of the invention is not intended to represent each embodiment or every aspect of the present invention.

### BRIEF DESCRIPTION OF THE DRAWINGS

Preferred embodiments of the present invention will now be described with reference to the accompanying drawings, in which:

FIG. 1 illustrates a prior art supply chain for raw materials;

FIGS. 2A and 2B illustrate an embodiment of the present invention;

FIG. 3 illustrates, by way of a time line, a representation of the way in which the present invention is implemented, in one form;

FIGS. 4A, 4B and 4C illustrate examples of the present invention as applied to a Hot Metal supply chain in as much as different supply strategies and product compositions are illustrated;

FIGS. 5A and 5B illustrate yet a further representation of the present invention;

FIG. 6 illustrates yet a further example of the present invention;

FIG. 7 illustrates yet another example of the present invention; and

FIG. 8 also illustrates another example of the present invention.

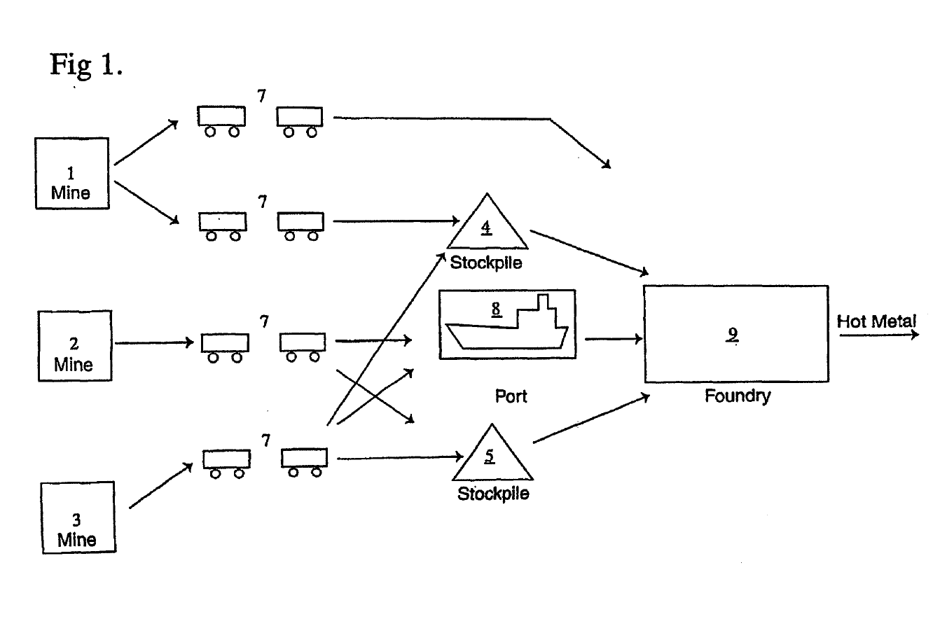

### DETAILED DESCRIPTION OF ILLUSTRATIVE EMBODIMENTS OF THE INVENTION

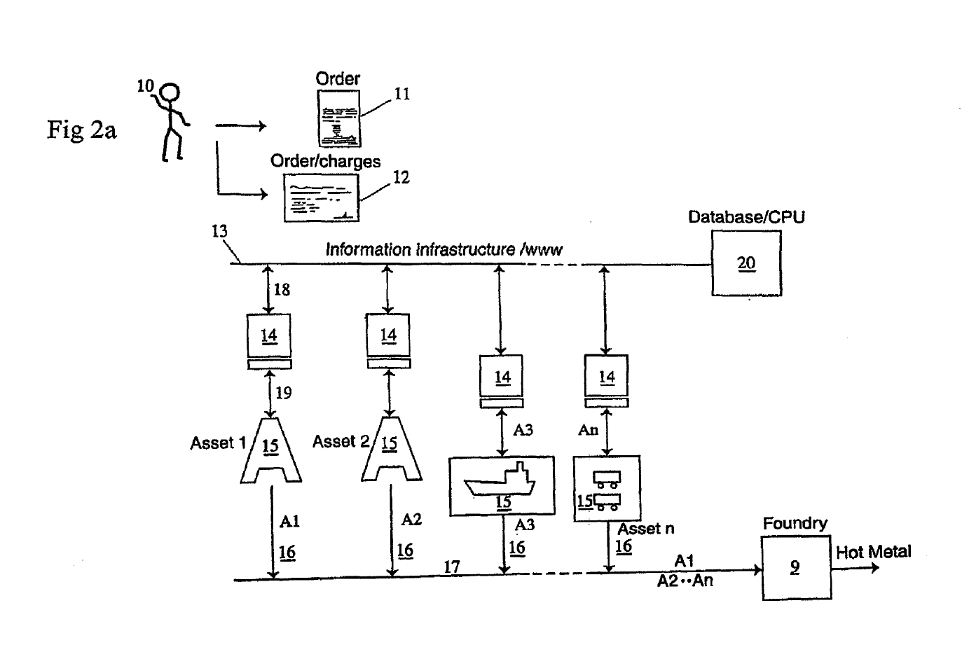

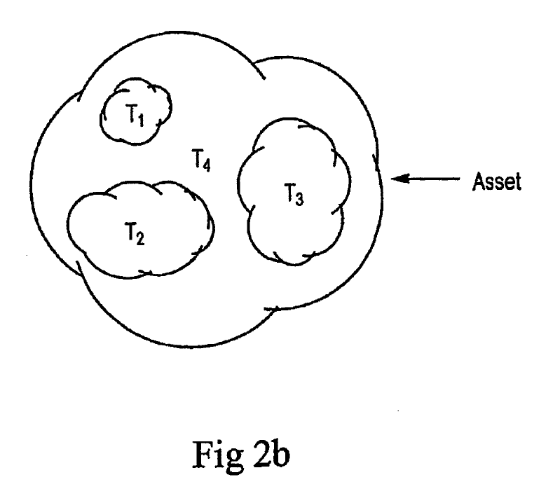

Referring to FIG. 2A, one overall generic description of the present invention can be made. A customer 10 places an order of processed product having specifications as set out in the order 11. The order includes, typically, quality and quantity of processed product, such as pig iron or other product as required. Subsequent changes 12 may also be made. This information is input to a database or computer 20. The computer or database then determines from this order which sources of raw materials or ore bodies, represented as ‘assets 1 to n’ and denoted by numeral 15 are to be used to supply raw materials to the foundry or refinery in order to produce a primary product (for example hot metal, Aluminum, stainless steel or blended coal) which fulfils the customers order and/or changes. The raw material(s) may be supplied from any ‘asset,’ whether from only one asset or a number of assets.

Referring to FIG. 2B, which represents an asset, such as a mine site, this illustrates that within an asset, there may be regions of raw materials of different compositions or characteristics (T1, T2, T3 T4, etc). These regions may also be listed as an ‘asset’ for the purpose of the present invention in as much as they may be included as a supply source for raw material(s). Equally, it may be possible that within a stockpile (not shown), different compositions or characteristics may also be located.

Also, known time delays (for example based on statistical or industry data) for raw material or primary product delivery or in-refinery or in-foundry processing requirements/delays can be factored in to meet the customers delivery schedule. For example, transport times or delays and foundry processing or production times can be taken into account in meeting the customer order requirements. These times can be utilised in determining the scheduling and management of supply as put to the raw material source.

The present invention, through its access to certain data, such as asset information, delays and various scenarios (provided or calculated), provides a determination and/or coordination of primary product to meet customer requirements.

This determination of the source of raw materials is possible because information regarding each ‘asset’ is provided or gathered locally, and on a continuous or periodic basis. In one embodiment, each asset is ‘tagged,’ in other words, identified uniquely. This unique tag may be associated with the particular asset throughout its journey to the end product and customer. This information is provided in the present invention at a local point 14 and/or by means of a ‘tag’ denoted in FIG. 2 as A1, A2, A3 through to An, each corresponding to their respective asset. The tag information may be reported daily and/or at certain points, as is required, in the overall product delivery and production process. The tag also enables the movement of the asset(s) to be monitored throughout the production delivery and process. The information provided locally at 14 is, for example:

Details describing the asset's fundamental physical properties and functional capabilities based on the system-wide business performance metrics: in the particular case of coking coal for Hot Metal, typical examples are ash, sulphur, phosphorus, vitrinite, volatile matter, fluidity, crucible swell number, moisture, sizing. Other information as is required may also be described,

Business parameters to be optimised by the system-wide solution and managed locally at the asset, namely, variable & fixed operating costs, assets mission life and return on investment, productivity and yield and availability, presence of raw materials in the processing assets, history of operational use and performance of the asset, details describing the designed operating envelop of the asset, schedule of planned use of the asset, operational status of the asset including current status, history and forecast status against schedule of planned use of the asset, asset's physical configuration as (a) options during the phase when a solution is being sought, as (b) the proposed set points and or utilisation strategy when a system-wide solution has been found, and as (c) the current operating set-up during operational use, asset's operational capabilities (a) during the phase when a solution is being sought and (b) the functional set-up when a solution is being executed, the processing step being performed by the asset in terms of when the step is being performed, the processing being done on the material by the processing asset, the geographical location of the asset and/or the material being processing by the asset.

It can well be appreciated that this ‘local information’ does not need to be stored ‘locally.’ For example, using well-known communication techniques it is understood that the ‘local information’ may be stored or be accessible at any point in a networked system. The ‘local’ information simply is required to relate ‘locally’ to the particular asset.

Based on this local information 14, the present invention has in its database 20, or has access to 14, data concerning the assets I to n. Thus, it is possible to know that a certain quantity of raw material having a certain composition which is required for a specific order is able to be sourced from an asset or a number of assets. The raw material may also be sourced from a stockpile or mine, where the local information 14 regards stockpile or mine characteristics and related data.

Based on this knowledge of where raw material can be sourced, a schedule for delivery of raw material and coordinating the arrival of raw material to the blast furnace (where possible) is determined. It may also be advantageous for a particular raw material to be ‘reserved’ for particular client or order. In other words, it is possible to ensure a specific raw material or quantity is for only specific orders or customers.

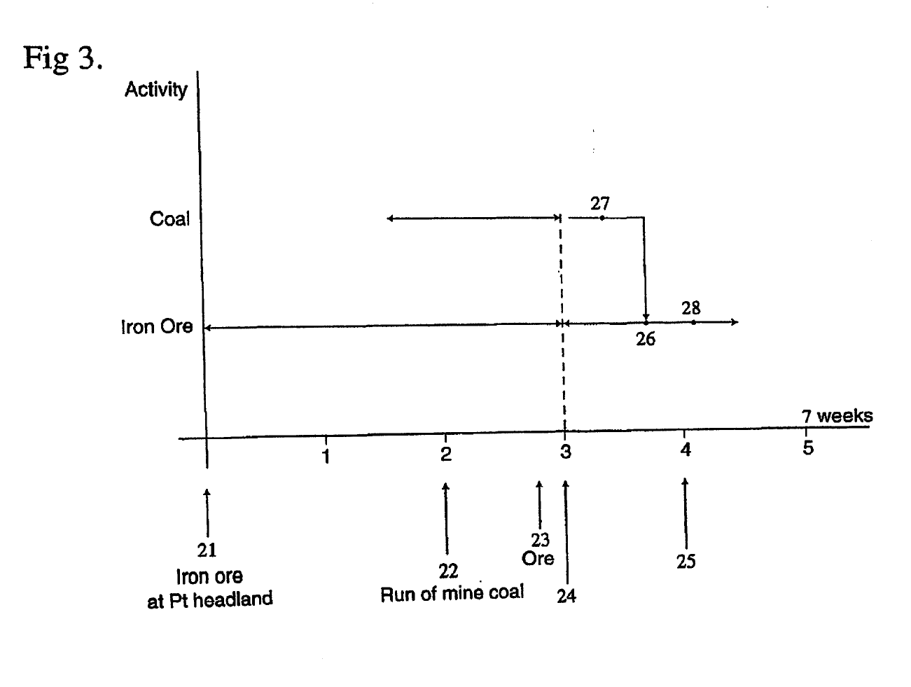

FIG. 3 illustrates schematically, by way of example, a schedule. The compositions and quantities of each raw material in order to produce the Hot Metal is taken in this example to have already been determined.

In parallel are coal and iron ore time lines, in weeks. At time 21, iron ore is source from Port Hedland. At time 22, coal is mined. It is to be understood that the iron ore and/or coal may be sourced from a plurality of assets. For simplicity, we describe one asset source for each of iron ore and coal. The present invention is not to be so limited, however. From FIG. 3, it can be seen that the iron ore and coal have been scheduled to arrive substantially at the same time 24 at the steel works, for example Port Kembla. The coal is coked in coke ovens at time 27, fed at time 26 to the blast furnace 28. The iron ore is also fed to the blast furnace at substantially that time. At time 25, Hot Metal can be obtained from a tap hole in the blast furnace. What the present invention provides, in one aspect, is the ability to have relatively good knowledge of the output from the blast furnace, in terms of quality, quantity, etc, given that there is provided relatively good and detailed data regarding the input raw materials to the furnace. The present invention also reduces or eliminates the need for stockpiled materials, the raw material(s) may be feed directly to the furnace is they are needed. If there is a given time delay for the steel works, based on data from the steel works, the time delay could be factored into a schedule for the delivery of product to the customer.

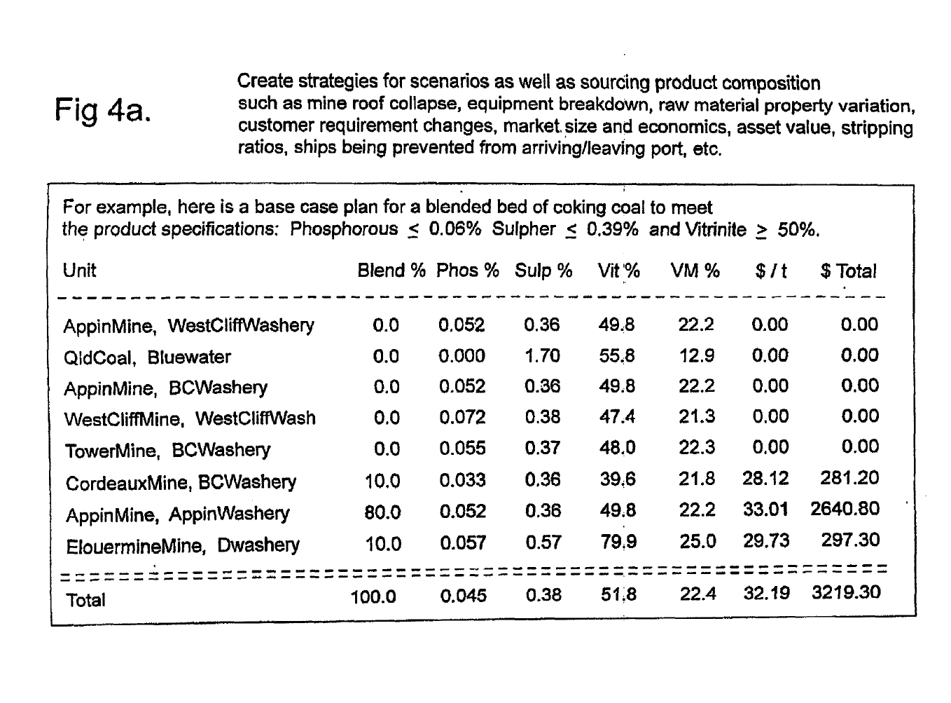

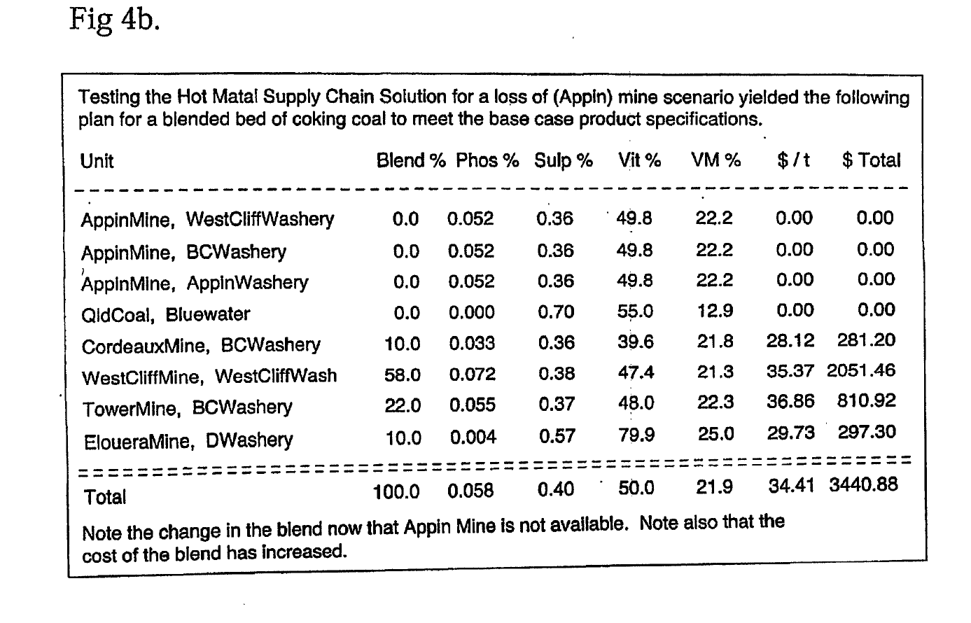

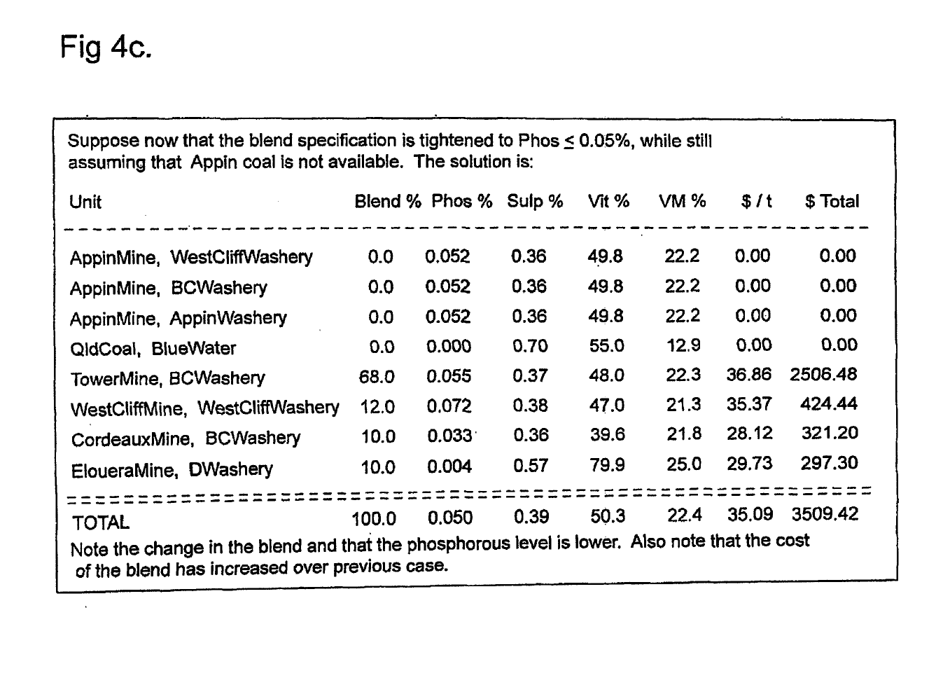

Figure tables 4A, 4B and 4C illustrate examples of the determination undertaken by the present invention, and as shown in the Tables 4A, 4B and 4C, there are example product compositions and from which ‘assets’ or ore bodies they are sourced. FIGS. 4A, 4B and 4C also illustrates that with the information 14 or tag associated with each asset, it is possible to provide a number of possible raw material and/or product supply/delivery to customers depending on events, as yet unpredictable in mining and product delivery operations. For example, what if, with reference to FIG. 4A, the ‘Appin Mine, Appinwashery’was unable to fulfill the delivery of raw material as requested in the initial determination of the present invention. The result is illustrated in FIG. 4B. The present invention, in continuously or periodically making determinations for each order and/or customer, enables a fresh determination to be made for such events. These determinations may also be made by way of predictions based on statistical information and or anticipated or possible scenarios. In the case illustrated, some raw material is now sourced from ‘WestCliffMine, WestCliffWash’ and some raw material is sourced from ‘TowerMine, BCWashery.’

In the situation where a fresh determination is made and raw material is altered, say, due to the need for management of unexpected events, the present invention may have to find a raw material or a number of raw material source(s), whilst not being exactly the same as the raw material which cannot be delivered, that most closely matches or is the most commercially effective, to the raw material which cannot be delivered.

In fact, in one embodiment of the present invention, it is contemplated that provision is made for the determination of a relatively large number (even 90 or more) alternative supply chains, each alternative supply chain being determined bearing in mind a change in the initially selected supply chain. In the example above, the ‘Appin Mine Appinwashery’ was unavailable. The present invention, in this form, would have determined, in advance, an alternative supply chain to meet such a scenario, and thus the customer order can continue to be met by way of utilising this alternative scenario.

This is done periodically, continuously and/or automatically by the assets running forward predictions derived from the information provided locally at 14 and/or system of the present invention running predictions to generate scenarios when particular assets and supply chains would not be viable and when assets and supply chains would be at optimal utilisation. This results in the generation of asset portfolio management strategies for current and future customer requirements. For example, scenarios may be generated based on one or a number of events, such as floods, labour force disruptions, earthquakes, geo-mechanical failure of a mine, changes in water tables, equipment failure, road or rail infrastructure disruptions, weather conditions, technical changes, processing times or delays, delivery/transport times or delays, likely customer order changes, foundry efficiency or delays or updates.

FIG. 4C illustrates the result of a fresh determination in which the product characteristics have been changed. The Phosphorous needs to be less than or equal to 0.005%. Resultant changes in the raw material sources can be seen as a consequence.

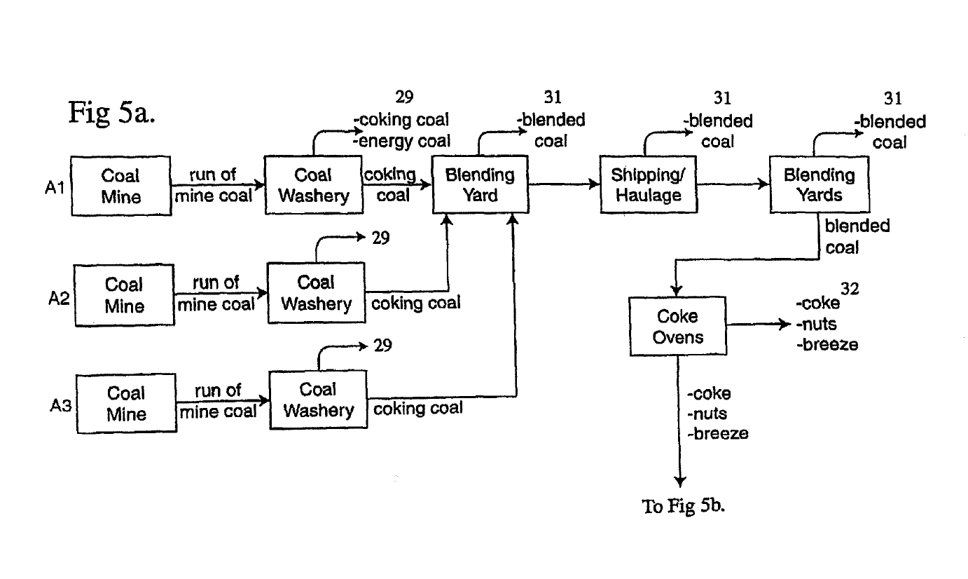

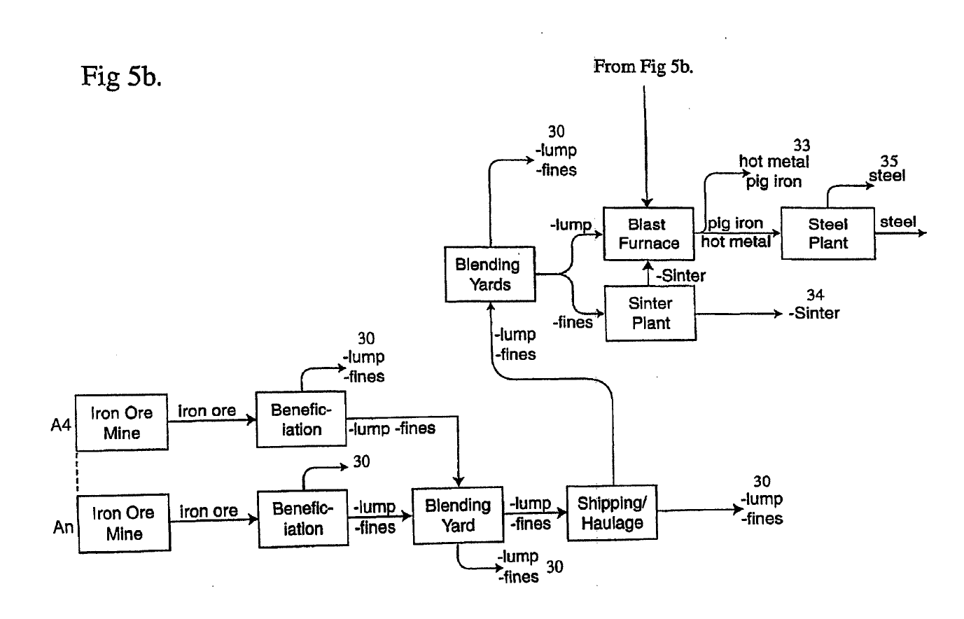

Referring to FIGS. 5A and 5B, another embodiment of the present invention is shown. By way of applying the essence of the present invention, it can be seen that the ‘primary product’ supplied in accordance with a customer's order does not need to be the final output of, for example, a steel making process. In fact, the present invention serves to provide a newly created supply chain for each primary product supplied in accordance with a customer order. Thus the present invention selects any one of, or a combination of, assets A1 to An in a manner that enables supply of the customer order.

The customer order may include coking and/or energy coal 29 from one or a number of assets, lump and/or fines 30 from one or a number of assets. Equally, the order may seek blended coal 31, coke, nuts and/or breeze 32, hot metal and/or pig iron 33, sinter 34, and/or steel 35. It is to be understood that the primary product is a raw material which has been processed or refined in some form. The invention is not limited to only these primary products, and may include any primary product within the coal, Aluminum and/or steel making industries.

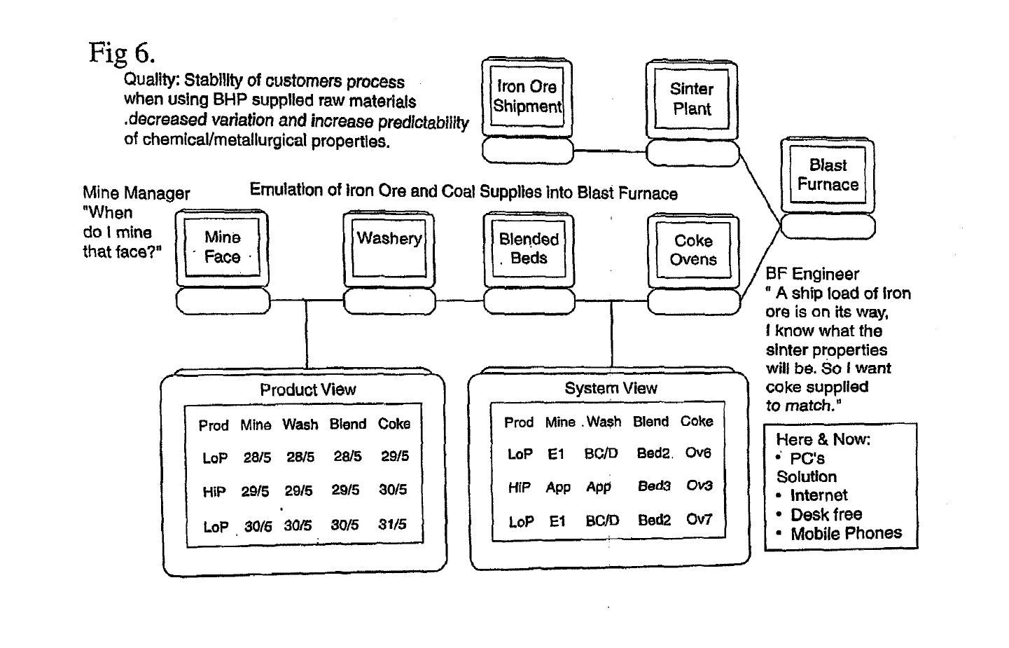

FIG. 6, illustrates another example of the present invention. Information regarding assets are displayed by product view, and/or by system view. Assets, such as mine face, washery, coke ovens, sinter plant, etc. provide the information to the present invention. Again, coordination of raw material delivery can be provided to the blast furnace. Again, the invention is not limited to only the iron ore and coal emulation depicted.

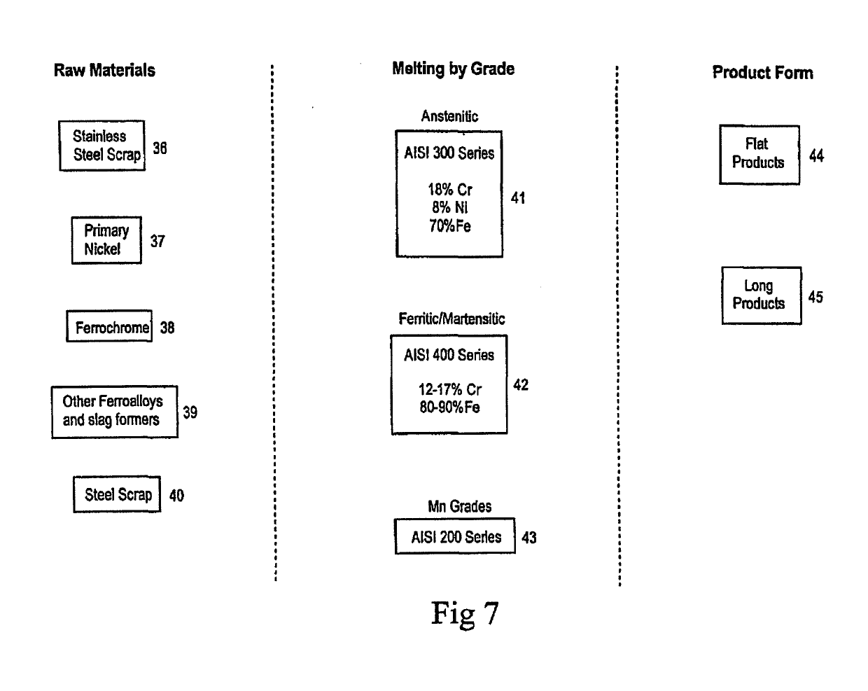

FIG. 7 illustrates one example of the present invention as applied to Stainless Steel production. In stainless steel production, a number of raw materials are sourced, such as stainless steel scrap 36, primary nickel 37, ferrochrome 38, other ferralloys and slay formers as would be known in the art 39 and scrap steel 40. The present invention as described above can be used to schedule the raw materials in a manner to suit customer orders and/or production requirements. The present invention may be used to produce anstenitic grade 41, ferritic/martensitic grade 42 and/or Mn grade stainless steel 43. These grades are typically used to produce flat products, such as sheet, strip ad plate, and long products, such as bar, rod and wire, for use in process plant, building and construction, transportation, food/beverage handling, automotive and consumer durables.

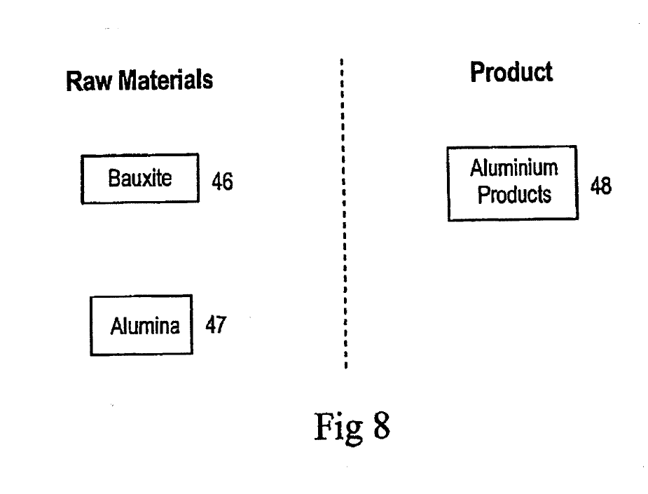

FIG. 8 illustrates one example of the present invention as applied to Aluminum production. In Aluminum production, a number of raw materials are sourced, such as bauxite 46, and alumina 47, such recycled aluminum scrap, as would be well known in the art. These raw materials are typically delivered to a refinery. The present invention as described above can be used to schedule the raw materials in a manner to suit customer orders and/or production requirements. The present invention may be used to produce Aluminum 48. Aluminum is typically used in many applications, as would be known in the art.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

What is claimed is:

1. A system comprising:
a network operable to provide information for production at a processing site of a primary product ordered by a customer;
a computer interoperably coupled to the network and operable to:
receive an order comprising a plurality of requirements for the primary product and a customer delivery date;
determine a plurality of raw materials needed to produce the primary product in accordance with the plurality of requirements and the customer delivery date, the plurality of raw materials not being present at the processing site; and
determine, via a network-accessible tag associated with each of a plurality of assets from which the plurality of raw materials may be obtained, information regarding the plurality of assets;
wherein the information comprises:
raw-material transport times to the processing site;
information regarding at least one of a physical property and a functional capability of each of the plurality of assets;
coordinate, based on the information regarding the plurality of assets, sourcing of the plurality of raw materials from at least one of the plurality of assets so that the customer delivery date is met with minimal underutilization of the plurality of raw materials; and
repeat the coordination of sourcing responsive to changes in the information regarding the plurality of assets.

2. The system of claim 1, wherein the information is obtained via the network on a continuous basis.

3. The system of claim 1, wherein sourcing of at least one of the plurality of raw materials is adjusted at least in part to a different asset of the plurality of assets responsive to changes in the information.

4. The system of claim 1, wherein the information comprises quality, quantity, and availability of raw materials associated with at least one asset of the plurality of assets.

5. The system of claim 1, wherein the computer is operable, via the network, to track the plurality of raw materials throughout movement of the plurality of raw materials from at least one asset of the plurality of assets to the processing site.

6. The system of claim 1, wherein the computer is operable to create a schedule for delivery of the plurality of raw materials to the production site based on the information regarding the plurality of assets.

7. The system of claim 1, wherein the computer is operable to reserve at least one raw material of the plurality of raw materials for the customer order.

8. A method comprising:
receiving, via a network, an order comprising a plurality of requirements for a primary product and a customer delivery date;
determining, by a computer interoperably coupled to the network, a plurality of raw materials needed to produce the primary product in accordance with the plurality of requirements and the customer delivery date, the plurality of raw materials not being present at the processing site;
determining, by the computer via a network-accessible tag associated with each of a plurality of assets from which the plurality of raw materials may be obtained, information regarding the plurality of assets;
wherein the information comprises:
raw-material transport times to the processing site;
information regarding at least one of a physical property and a functional capability of each of the plurality of assets;
coordinating, by the computer based on the information regarding the plurality of assets, sourcing of the plurality of raw materials from at least one of the plurality of assets so that the customer delivery date is met with minimal underutilization of the plurality of raw materials; and
repeating by the computer of the coordinating step responsive to changes in the information regarding the plurality of assets.

9. The method of claim 8, comprising the computer obtaining the information via the network on a continuous basis.

10. The method of claim 8, wherein sourcing at least one of the plurality of raw materials is changed at least in part to a different asset of the plurality of assets responsive to changes in the information.

11. The method of claim 8, wherein the information comprises quality, quantity, and availability of raw materials associated with at least one asset of the plurality of assets.

12. The method of claim 8, comprising tracking movement of at least one raw material of the plurality of raw materials throughout a portion of movement of the at least one raw material from at least one asset of the plurality of assets to the processing site.

13. The method of claim 8, comprising creating a schedule for delivery of at least one raw material of the plurality of raw materials to the production site based on the information regarding the plurality of assets.

14. A method comprising:
creating, via a computer interoperably coupled to a network, a supply chain of a plurality of raw materials not present at a processing site, the supply chain applicable to a customer order for a primary product to be produced at the processing site;
wherein the supply chain comprises a plurality of assets from which the plurality of raw materials are to be sourced;
tracking, by the computer via the network, each of the plurality of assets via a network-accessible tag associated with each of the plurality of assets;
wherein the tracking step comprises the computer receiving information via the network from the network-accessible tag, the information comprising raw-material transport times to the processing site and information regarding a physical property and a functional capability of each of the plurality of assets;
responsive to the tracking step, modifying the supply chain via the computer and the network;
wherein the modifying step comprises replacing at least one of the plurality of assets with a different asset of the plurality of assets.

15. The method of claim 14, wherein the information is obtained via the network on a continuous basis.

16. The method of claim 14, wherein the information comprises quality, quantity, and availability of the plurality of raw materials.

17. The method of claim 14, comprising tracking movement of the plurality of raw materials throughout movement of the plurality of raw materials from at least one asset of the plurality of assets to the processing site.

18. The method of claim 14, comprising creating a schedule for delivery of at least one raw material of the plurality of raw materials to the production site based on the information regarding the plurality of assets.
